(19) United States
(12) Patent Application Publication
(10) Pub. No.: US 2024/0123999 A1
(43) Pub. Date: Apr. 18, 2024

(54) Predicting a Future Actual Speed of a Motor Vehicle

(71) Applicant: Bayerische Motoren Werke Aktiengesellschaft, Muenchen (DE)

(72) Inventors: Luca PUCCETTI, Neufahrn (DE); Ahmed YASSER, Muenchen (DE)

(21) Appl. No.: 18/277,458

(22) PCT Filed: Feb. 3, 2022
(86) PCT No.: PCT/EP2022/052611

§ 371 Date: Aug. 16, 2023

(30) Foreign Application Priority Data
Mar. 17, 2021 (DE) 10 2021 106 515.1

(51) Int. Cl. B60W 50/00; B60W 30/14

(52) U.S. Cl. CPC B60W 50/0097; B60W 30/143; B60W 2050/0056; B60W 2520/10; B60W 2720/106

(57) ABSTRACT

A device for predicting a future actual speed of a motor vehicle includes a low-pass filter, the low-pass filter being configured to filter a signal which is characteristic of a target speed of the motor vehicle and to provide this as a target speed of the motor vehicle; an acceleration governor, the acceleration governor being configured to predetermine a target acceleration for the motor vehicle in a time interval depending at least on the target speed of the motor vehicle; and a model, the model being configured to predict the future actual speed depending at least on the target acceleration.

### BACKGROUND AND SUMMARY OF THE INVENTION

The invention relates to a device for predicting a future actual speed of a motor vehicle.

The term “autonomous driving” can be understood for the purposes of this document to mean driving with automated longitudinal or lateral guidance, or autonomous driving with automated longitudinal and lateral guidance. The term “autonomous driving” covers automated driving with any degree of automation. Examples of levels of automation are an assisted, partially automated, highly automated or fully automated driving mode. These levels of automation have been defined by the German Federal Highway Research Institute (BASt). During assisted driving, the driver performs the longitudinal or lateral guidance all the time, while the system performs the other function within certain limits. In partially automated driving (PAD), the system takes control of the longitudinal and lateral guidance for a certain period of time and/or in specific situations while the driver has to constantly monitor the system, as in assisted driving. In highly automated driving (HAD), the system takes control of the longitudinal and lateral guidance for a certain period of time without the driver having to constantly monitor the system; however, the driver must be in a position to take control of the vehicle within a certain period of time. In fully automated driving (FAD), the system can automatically handle the driving in all situations for a specific application; for this application a driver is no longer required. The four automation levels listed above according to the BASt definition correspond to SAE levels 1 to 4 of the SAE J3016 standard (SAE—Society of Automotive Engineering). For example, highly automated driving (HAD) according to the BASt complies with level 3 of the SAE J3016 standard. In addition, SAE J3016 also provides SAE level 5 as the highest automation level, which is not included in the BASt definition. SAE level 5 is equivalent to driverless driving, in which the system can automatically handle all situations in the same way as a human driver throughout the entire journey; a driver is generally no longer required.

It is the object of the invention to simplify the prediction of a future actual speed of a motor vehicle.

One aspect of the invention relates to a device for predicting a future actual speed of a motor vehicle.

The device comprises a low-pass filter. The low-pass filter is a filter that allows signal components with frequencies below their cutoff frequency to pass almost unattenuated, whereas components with higher frequencies are attenuated.

The low-pass filter is designed to filter a signal which is characteristic of a target speed of the motor vehicle and to provide this as the target speed of the motor vehicle.

In addition, the device comprises an acceleration governor, wherein the acceleration governor is designed to predetermine a target acceleration of the motor vehicle in a time interval at least depending on the target speed of the motor vehicle.

In addition, the device comprises a model, wherein the model is designed to predict the future actual speed at least depending on the target acceleration.

In an advantageous embodiment of the invention, the acceleration governor is designed to additionally predetermine the target acceleration of the motor vehicle depending on an actual speed of the motor vehicle and a gain factor.

Alternatively or additionally, the model is designed to predict the future actual speed additionally depending on the actual speed.

In a further advantageous embodiment of the invention, the device is designed to store as information each of the target speed, the actual speed and the target acceleration predetermined depending on the actual speed for at least two time intervals, to select a first subset of the information, to train the model depending on the first subset, to select a second subset of the information and to adjust the gain factor depending on the second subset, the model and the acceleration governor.

In particular, embodiments of the invention comprise a device for adjusting a gain factor of an acceleration governor for a motor vehicle, in particular for an automated motor vehicle.

The acceleration governor is designed to predetermine a target acceleration for the motor vehicle in a time interval, depending on a target speed of the motor vehicle, an actual speed of the motor vehicle and the gain factor.

The longitudinal guidance of the motor vehicle then takes place at least depending on the target acceleration. In particular, the target acceleration of a drive or engine control unit is specified as the final acceleration. Alternatively or additionally, the target acceleration is still processed before it is specified to the drive or motor control unit as the final acceleration.

The device is designed to store as information each of the target speed, the actual speed and the target acceleration predetermined depending on the actual speed for at least two time intervals.

In particular, the device is designed to store each of the target speed, the actual speed and the target acceleration predetermined depending on the actual speed as a tuple, so that it can be further derived from the stored information that the aforementioned data corresponds to the same time interval.

The device is designed in particular to store as information each of the target speed, the actual speed, the target acceleration predetermined depending on the actual speed, and the respective time interval for at least two time intervals, so that a causal or temporal sequence of the aforementioned data can also be derived from the stored information.

Furthermore, the device is designed to select a first subset of the information, wherein the first subset in particular comprises a maximum of 150 or 200 tuples of target speed, actual speed and/or target acceleration. This aspect of the invention is based on the finding that the number of tuples is selected in such a way that processing is possible under real-time conditions, i.e. in strict compliance with a time limit.

The device is designed to train a model depending on the first subset, wherein the model is designed to predict an actual speed of a later time interval from at least one stored actual speed and at least one stored target acceleration.

This aspect of the invention is based on the finding that, taking into account the time difference between a first time interval and a second time interval subsequent to the first time interval, the actual speed during the second time interval can be predicted from the actual speed and the target acceleration during a first time interval.

An actual acceleration of the motor vehicle will often deviate from the target acceleration of the motor vehicle, as the actual acceleration not only depends on influences that can be controlled by the motor vehicle, e.g. the slope of the road, signal propagation times in the motor vehicle and/or system inertia values. However, since the actual speed of the motor vehicle is stored for multiple time intervals and is thus known, the model can be trained retrospectively using a supervised learning procedure.

The device is additionally designed to select a second subset of the information, wherein the second subset in particular comprises a maximum of 20, 50, 100 or 150 tuples of target speed, actual speed and/or target acceleration.

In addition, the device is designed to adjust the gain factor depending on the second subset, the model and the acceleration governor.

The invention is based on the finding that the selection of the gain factor has a significant influence on how quickly and with what quality the actual speed of the motor vehicle is adjusted to match a target speed deviating therefrom. For example, a very large gain factor can ensure that the actual speed is quickly adjusted to the target speed, but a very large gain factor in conjunction with time delays may risk causing oscillations.

The device is designed in particular to train the model and adjust the acceleration governor multiple times in order to converge iteratively to an optimal gain factor. For example, by appropriately selecting the frequency at which the model is trained and the acceleration governor is adjusted, an optimum can be found using negligible computing power.

The acceleration governor is designed in particular to determine the target acceleration from the product of the gain factor and the difference between the target speed and the actual speed.

In particular, the device is designed to store the information in a ring buffer, wherein a capacity of the ring buffer is limited to storing the information of a maximum of 5000 time intervals.

A ring buffer stores data continuously over a certain period of time and overwrites it after a predetermined time has elapsed in order to free up memory space for new data.

In particular, the time difference between two time intervals is at most 20 ms, so that the ring buffer can store at most information from an interval of 100 s.

The device is designed in particular to train the model by optimizing a first weighting factor and a second weighting factor in such a way that a prediction error of the model is minimized.

In particular, the optimization of the first weighting factor and the second weighting factor is carried out using a Levenberg-Marquardt algorithm. This aspect of the invention is based on the finding that, in the context of the given problem, the Levenberg-Marquardt algorithm converges very quickly in comparison to other optimization algorithms, which, in conjunction with further measures, allows the invention to be used in a motor vehicle (i.e. “online”, compared to “offline” training in a data center).

The first weighting factor specifies an influence of the at least one stored actual speed on the prediction. In particular, if the at least one stored actual speed comprises more than just one actual speed, a plurality of first weighting factors can be used. For example, a separate first weighting factor can be used for each of the plurality of actual speeds.

The second weighting factor specifies an influence of the at least one stored target acceleration on the prediction. In particular, if the at least one stored target acceleration comprises more than just one target acceleration, a plurality of second weighting factors can be used. For example, a separate second weighting factor can be used for each of the plurality of target accelerations.

The device is designed in particular to adjust the gain factor, wherein the device is designed to predict a state of the motor vehicle depending on the second subset, the model and the acceleration governor.

The state of the motor vehicle is in particular a description of the actual dynamics of the motor vehicle and/or a description of control or target specifications for systems of the motor vehicle, which will influence the dynamics of the motor vehicle in the future. For example, the state of the motor vehicle comprises a target acceleration of the motor vehicle for the current time interval, an actual speed of the motor vehicle for the current time interval, and a target speed of the motor vehicle for the current time interval. In addition, the state of the motor vehicle may also comprise an actual speed for at least one past time interval and/or a target acceleration for at least one past time interval.

In particular, since the complete state of the motor vehicle can only be described in a very complex manner, the state of the motor vehicle in the present embodiment of the invention can only be described in part, for example by at least one actual speed of the motor vehicle, at least one target speed of the motor vehicle, and/or at least one target acceleration of the motor vehicle.

In addition, the device is designed to adjust the gain factor in such a way that a control quality measure related to the state of the motor vehicle is minimized.

The control quality measure describes in particular a control deviation and/or a measure of passenger comfort.

The adjustment of the gain factor is carried out in particular with a Levenberg-Marquardt algorithm. This aspect of the invention is based on the finding that, in the context of the stated problem, the Levenberg-Marquardt algorithm converges very quickly in comparison to other optimization algorithms, which, in conjunction with further measures, allows the invention to be used in a motor vehicle.

The state of the motor vehicle comprises in particular at least one actual speed of the motor vehicle and/or at least one target acceleration of the motor vehicle and/or at least one target speed of the motor vehicle in a time interval.

For example, by way of the model, starting from an initial state of the motor vehicle, a forecast can be created for how the target acceleration, the target speed and the actual speed of the motor vehicle will develop in future time intervals if different values for the gain factor of the acceleration governor are assumed.

The device is designed in particular to store the information in a ring buffer, wherein a capacity of the ring buffer is limited to storing the information of a maximum of 5000 time intervals; to train the model, wherein a first weighting factor and a second weighting factor are optimized with a Levenberg-Marquardt algorithm in such a way that a prediction error of the model is minimized, wherein the first weighting factor specifies an influence of the at least one stored actual speed on the prediction, and wherein the second weighting factor specifies an influence of the at least one stored target acceleration on the prediction; and to adjust the gain factor, wherein a state of the motor vehicle is predicted depending on the second subset, the model and the acceleration governor; and to optimize the gain factor with a Levenberg-Marquardt algorithm in such a way that a control quality measure related to the state of the motor vehicle is minimized.

This combines all the features that make the invention sufficiently efficient that, despite the limited resources of automotive control units, the use of embodiments of the invention is possible directly in the motor vehicle.

In another advantageous embodiment, the device comprises an acceleration prediction unit, wherein the acceleration prediction unit is designed to determine a correction acceleration depending on the target speed, and the model is designed to additionally predict the future actual speed depending on the correction acceleration.

The acceleration prediction unit comprises in particular a precontrol, in order to compensate for the working time, or working duration, of the device.

In particular, the model is designed to predict the future actual speed depending on the sum of the correction acceleration and the target acceleration.

In a further advantageous embodiment, the device is designed to automatically set the acceleration prediction unit as a product of an inversion of a transfer function of the model and a causality factor.

In particular, the causality factor is a delay operator.

It is necessary to use the causality factor to obtain a causal system as an acceleration prediction unit. A causal system is in particular a physically feasible system. This means that the output value of the system depends only on the current and past input values, and not on future input values. Put simply, an effect occurs at the earliest at the time of the cause, but not earlier.

The transfer function of the model is a transformed operator representation of the system equation of the model, which makes it possible to solve differential equations by algebraic transformations.

The inversion of the transfer function of the model describes the dynamic response that generates from a target signal the actuating signal that, when entered into the original system, causes its output to follow the target signal.

In a further advantageous embodiment of the invention, the device comprises a reference filter, wherein the reference filter is designed to determine a filtered target speed depending on the target speed, and the acceleration governor is designed to predetermine a target acceleration of the motor vehicle at least depending on the filtered target speed of the motor vehicle.

In particular, the reference filter is designed to predetermine the filtered target speed depending on the target speed without a time delay due to the working time, or working duration, of the device.

In particular, the device is designed to automatically determine the reference filter. For example, the device is designed to determine a transfer function of the reference filter from a product of a transfer function of the acceleration prediction unit and a transfer function of the model.

In a further advantageous embodiment of the invention, the device is designed to automatically define the acceleration prediction unit.

The transfer function of the acceleration prediction unit is a transformed operator representation of the system equation of the acceleration prediction unit.

The invention is described in further detail below using an exemplary embodiment and with the aid of the attached drawings.

### BRIEF DESCRIPTION OF THE DRAWINGS

FIG. 1 shows a device according to an embodiment of the invention for predicting a future actual speed of a motor vehicle.

FIG. 2 shows a device according to an embodiment of the invention for adjusting a gain factor of an acceleration governor of a motor vehicle.

### DETAILED DESCRIPTION OF THE DRAWINGS

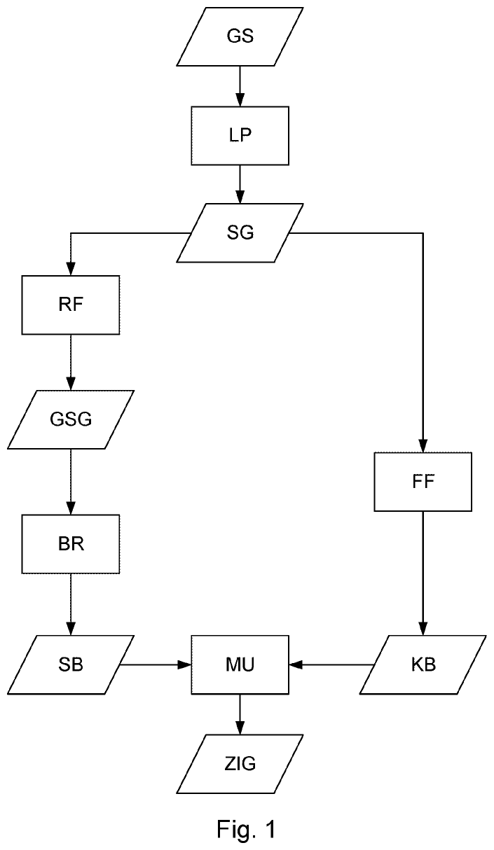

FIG. 1 shows a device according to an embodiment of the invention for predicting a future actual speed ZIG of a motor vehicle.

The device comprises a low-pass filter LP, wherein the low-pass filter LP is designed to filter a signal GS which is characteristic of a target speed of the motor vehicle and to provide this as the target speed SG of the motor vehicle. This aspect of the invention is based on the finding that high-frequency components of the signal GS which is characteristic of the target speed of the motor vehicle would lead to large fluctuations of the acceleration prediction unit FF. These are prevented by using the low-pass filter LP.

In addition, the device comprises an acceleration governor BR, wherein the acceleration governor BR is designed to predetermine a target acceleration SB of the motor vehicle in a time interval at least depending on the actual speed IG of the motor vehicle.

The acceleration governor BR is also designed to predetermine the target acceleration SB of the motor vehicle additionally depending on a target speed SG of the motor vehicle and a gain factor VF.

In addition, the device comprises a model MU, wherein the model MU is designed to predict the future actual speed ZIG at least depending on the target acceleration SB.

The model MU is also designed to predict the future actual speed ZIG additionally depending on the actual speed IG.

The device comprises an acceleration prediction unit FF, wherein the acceleration prediction unit FF is designed to determine a correction acceleration KB depending on the target speed SG.

The model MU is also designed to predict the future actual speed ZIG additionally depending on the correction acceleration KB.

The device is designed to automatically define the acceleration prediction unit FF as a product of an inversion of a transfer function of the model MU and a causality factor.

The device also comprises a reference filter RF, wherein the reference filter RF is designed to determine a filtered target speed GSG depending on the target speed SG, and the acceleration governor BR is designed to predetermine a target acceleration SB of the motor vehicle at least depending on the filtered target speed GSG of the motor vehicle.

In addition, the device is designed to automatically define the reference filter RF as a product of a transfer function of the acceleration prediction unit FF and a transfer function of the model MU.

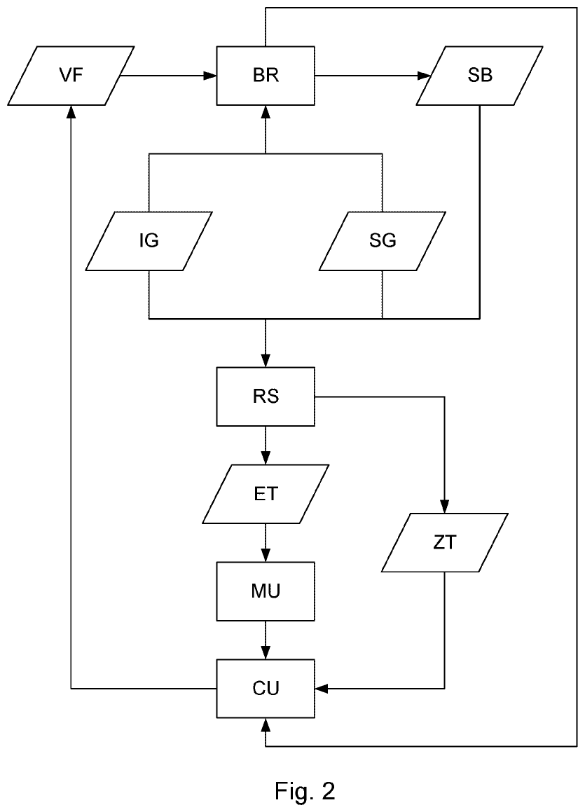

FIG. 2 shows a device according to an embodiment of the invention for adjusting a gain factor VF of an acceleration governor BR of a motor vehicle.

The acceleration governor BR is designed to predetermine a target acceleration SB of the motor vehicle in a time interval depending on a target speed SG of the motor vehicle, an actual speed IG of the motor vehicle, and the gain factor VF.

In addition, the acceleration governor BR is designed to determine the target acceleration SB from the product of the gain factor VF and the difference between the target speed SG and the actual speed IG.

The device is designed to store as information each of the target speed SG, the actual speed IG and the predetermined target acceleration SB for at least two time intervals.

In particular, the device is designed to store the information in a ring buffer RS, wherein a capacity of the ring buffer RS is limited to storing the information of a maximum of 5000 time intervals.

In addition, the device is designed to select a first subset ET of the information, and to train a model MU depending on the first subset ET, wherein the model MU is designed to predict an actual speed IG of a later time interval from at least one stored actual speed IG and at least one stored target acceleration SB.

In particular, the device is designed to train the model MU by optimizing a first weighting factor and a second weighting factor in such a way that a prediction error of the model MU is minimized, wherein the first weighting factor specifies an influence of the at least one stored actual speed IG on the prediction, and wherein the second weighting factor specifies an influence of the at least one stored target acceleration SB on the prediction.

In addition, the device is designed to select a second subset ZT of the information, and to adjust the gain factor VF depending on the second subset ZT, the model MU and the acceleration governor BR, for example by using an optimization device CU.

In particular, the device is designed to adjust the gain factor VF by the device being designed to predict a state of the motor vehicle depending on the second subset ZT, the model MU and the acceleration governor BR, and to adjust the gain factor VF in such a way that a control quality measure related to the state of the motor vehicle is minimized.

The state of the motor vehicle comprises at least an actual speed IG of the motor vehicle and/or at least a target acceleration SB of the motor vehicle in a time interval.

1.-7. (canceled)

8. A device for predicting a future actual speed of a motor vehicle, the device comprising:
a low-pass filter, wherein the low-pass filter is configured to filter a signal which is characteristic of a target speed of the motor vehicle and to provide the signal as the target speed of the motor vehicle;
an acceleration governor, wherein the acceleration governor is configured to predetermine a target acceleration of the motor vehicle in a time interval depending at least on the target speed of the motor vehicle; and
a model, wherein the model is configured to predict the future actual speed depending at least on the target acceleration.

9. The device as claimed in claim 8, wherein:
the acceleration governor is configured to predetermine the target acceleration of the motor vehicle depending additionally on an actual speed of the motor vehicle and a gain factor, and/or
the model is configured to predict the future actual speed depending additionally on the actual speed.

10. The device as claimed in claim 9, wherein the device is configured:
to store as information each of the target speed, the actual speed, and the target acceleration for at least two time intervals,
to select a first subset of the information,
to train the model depending on the first subset,
to select a second subset of the information, and
to adjust the gain factor depending on the second subset, the model, and the acceleration governor.

11. The device as claimed in claim 11, further comprising:
an acceleration prediction unit, wherein the acceleration prediction unit is configured to determine a correction acceleration depending on the target speed,
wherein the model is configured to predict the future actual speed depending additionally on the correction acceleration.

12. The device as claimed in claim 11, wherein the device is configured to automatically define the acceleration prediction unit as a product of an inversion of a transfer function of the model and a causality factor.

13. The device as claimed in claim 11, further comprising:
a reference filter, wherein the reference filter is configured to determine a filtered target speed depending on the target speed,
wherein the acceleration governor is configured to predetermine the target acceleration of the motor vehicle depending additionally on the filtered target speed of the motor vehicle.

14. The device as claimed in claim 13, wherein the device is configured to automatically set the reference filter as a product of a transfer function of the acceleration prediction unit and a transfer function of the model.
